(19) United States
(12) Patent Application Publication
(10) Pub. No.: US 2009/0027891 A1
(43) Pub. Date: Jan. 29, 2009

(54) BEAM SHAPERS USING ELECTRICALLY CONTROLLABLE SCATTERING

(75) Inventors: Rifat Ata Mustafa Hikmet, Eindhoven (NL); Johannes Petrus Maria Ansems, Eindhoven (NL); Christoph Gerard August Hoelen, Eindhoven (NL); Ties Van Bommel, Eindhoven (NL); Lingli Wang, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,059

(22) PCT Filed: Oct. 10, 2005
(86) PCT No.: PCT/IB05/53321

§ 371 Date: Apr. 11, 2007

(30) Foreign Application Priority Data
Oct. 18, 2004 (EP) 04105104.6

(51) Int. Cl. F21V 7/00

(52) U.S. Cl. 362/296.02; 362/341

(57) ABSTRACT

The present invention relates to a device (200) for electrically controlling shaping of a light beam. The device comprises primary optics (202) that is arranged to shape the light beam originating from a light source (201). The device further comprises an electrically controllable optical element (203) arranged to change the direction of the light falling onto it, when the element is in a light-redirecting mode. The optical element can be an electrically controllable scattering element e.g. created by using a PDLC material or an LC gel. The degree of light redirection of the optical element is controlled by applying an electric field to the LC material. Finally, the device comprises secondary optics (204) arranged to shape the scattered, diffracted or refracted light beam from the optical element.

The present invention relates to a device for electrically controlling shaping of a light beam.

In many optical applications, it is desirable to control shape and direction of light originating from a light source, such as a light emitting diode (LED). In many applications, it is desirable to be able to control the shape of the light beam. Typically, a spot light that uses a reflector has a divergence of about 10° full-width half-maximum (FWHM) and flood light divergence is about 40° FWHM. In this context, the FWHM parameter is defined as the divergence angle at half the maximum intensity. In prior art, electrically switchable optical components such as lens arrays have been proposed to actively control the shape of a light beam. These types of components are, however, based on replication techniques that are expensive to implement in optical devices and systems. Moreover, most such components typically use cells where the liquid crystal molecules are uniaxially oriented parallel to the cell surface. In such a cell, application of an electric field alters only one of the polarization directions and thus only 50% of unpolarised light. In order to influence the other polarization direction, a second cell must be used. Disadvantageously, this results in significant additional losses of emitted light.

Electrically controlled scattering of light can be accomplished in many different ways. A common approach for accomplishing electrically controlled light scattering is to utilize polymer dispersed liquid crystals (PDLCs) or liquid crystal gels. PDLCs are created by means of dispersing liquid crystal molecules in an isotropic polymer. Typically, liquid crystal material is arranged between two glass plates with transparent electrodes, whereby a cell is formed. When no electric field is applied between the glass plates, the liquid crystals are randomly oriented which creates a scattering mode, wherein light is scattered in many directions. By applying an electric field, the scattering gradually decreases, and when the liquid crystals align parallel to the electric field, the crystal molecule refractive index match the polymer refractive index, wherein a transparent mode is created and light passes through the cell. LC gels on the other hand are created by dispersing liquid crystals in an oriented anisotropic polymer matrix. For LC gels with a negative dielectric anisotropy, the transparent mode is present when no electric field is applied. In the absence of an electric field, liquid crystal molecules are oriented in a direction perpendicular to the cell surfaces and consequently, there are no large-scale refractive index fluctuations within the LC cell. When an electric field is applied, the liquid crystals tend to become oriented perpendicular to the electric field and refractive index fluctuations are induced within the LC cell, and thus the scattering mode is activated.

European patent application having publication number 0 578 827 discloses an illuminator provided with a light source, a liquid crystal light regulating plate for scattering a desired amount of light emitted from the light source, and a control power source for controlling the light scattering rate of the liquid crystal plate. A part of the light emitted from the light source, which passes through the liquid crystal light regulating plate without being scattered, is utilized for illumination. By changing a control power source voltage applied for controlling the light scattering rate, it is possible to continuously change brightness of the illuminating light.

A problem in the publication 0 578 827 is that the liquid crystal light regulating plate scatters light to very large angles when operating in the particular voltage state that attains the scattering effect. When such an illuminator illuminates an object, a part of the light beam of the illuminator will not be incident on or adjacent to the object, but will be scattered to very large angles, away from the object. As a consequence, the regulating plate causes a light dimming effect.

An object of the present invention is to overcome the above-described problems and provide a device that enables electrically controlled shaping of light beams.

This object is attained by a device for electrically controlling shaping of a light beam according to claim 1.

In a first aspect of the present invention, there is provided a device comprising primary optics arranged to shape the light beam, an electrically controllable optical element arranged to alter the shaped light beam when in a light redirecting mode, and secondary optics arranged to shape the light beam altered by the electrically controllable optical element.

A basic idea of the present invention is to provide a device that enables electrically controlled shaping of a light beam. The device comprises primary optics that is arranged to shape the light beam. The light beam typically originates from a light source such as a LED, a laser or some other appropriate light source. The device further comprises an electrically controllable optical element arranged to change the direction of the light falling onto it when the element is in a light-redirecting mode. The optical element can be an electrically controllable scattering element e.g. created by using a PDLC material or liquid crystal (LC) gel. It can alternatively be a diffractive or refractive element. The degree of diffraction or scattering of the optical element is controlled by applying an electric field to the liquid crystal material, whereby the degree of scattering, diffraction or refraction varies with the applied electric field. Hence, in the light-redirecting mode, the optical element can e.g. scatter, diffract or refract the light impinging on it. Finally, the device comprises secondary optics arranged to shape the scattered, diffracted or refracted light beam from the optical element.

The present invention is advantageous, since it provides a polarization independent scattering effect, which can be realized using a single cell configuration. The optical element partially shifts the virtual position of the light source to a position at the optical element. Hence, the primary optics has the LED as the effective light source, while the secondary optics has the scattering element as the effective light source. Depending on the voltage that is applied to the optical element, the angular intensity pattern of the scattered, diffracted or refracted beam (i.e. the beam intensity versus beam divergence) can be varied.

According to an embodiment of the present invention, the primary optics is arranged to provide maximum light extraction as well as collimation for the part of the beam originating from the light source, the electrically controllable optical element is arranged to scatter the beam when in a scattering mode, and the secondary optics is arranged to shape light falling onto it to have a wider angular distribution. The secondary optics is further arranged to shape the non-scattered beam originating from the light source, which is not shaped by the primary optics when the electrically controllable optical element is arranged in a transparent mode. This embodiment is advantageous, since the total size of the primary and secondary optics becomes rather small when both the primary optics and the secondary optics are employed to shape the beam originating from the light source.

Further features of, and advantages with, the present invention will become apparent when studying the appended claims and the following description. Those skilled in the art realize that different features of the present invention can be combined to create embodiments other than those described in the following.

Preferred embodiments of the present invention will be described in more detail with reference made to the accompanying drawings, in which:

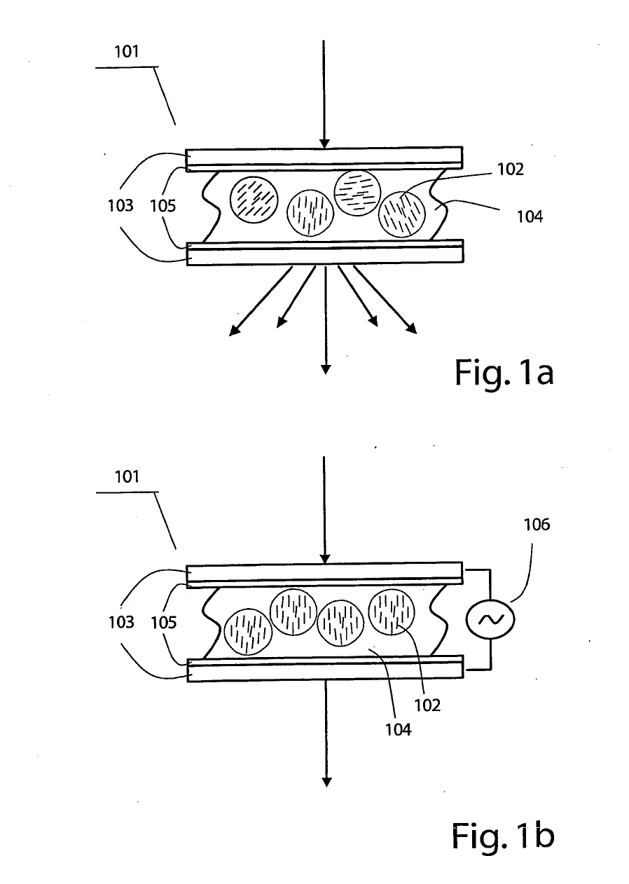

FIG. 1 shows a cross sectional view of a prior art electrically controllable scattering element, which element is formed by using a PDLC material;

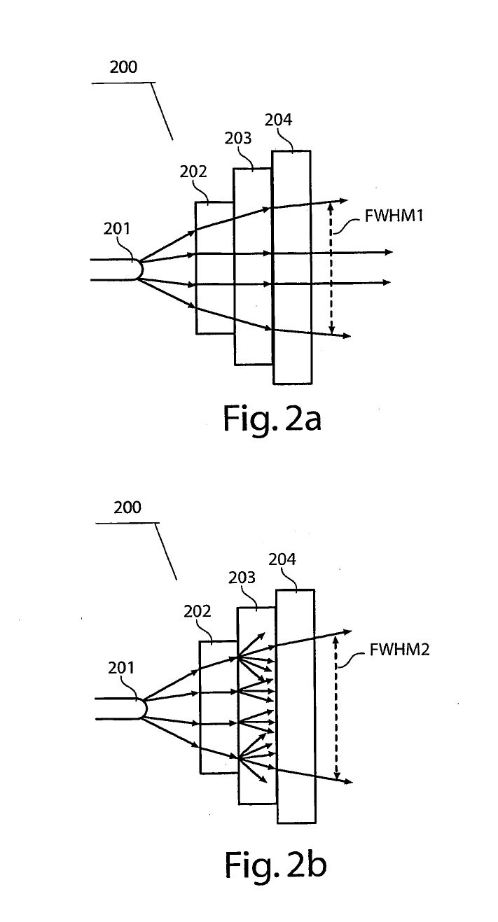

FIG. 2 shows a cross sectional view of an embodiment of the present invention, in which a device for electrically controlling shaping of a light beam is provided;

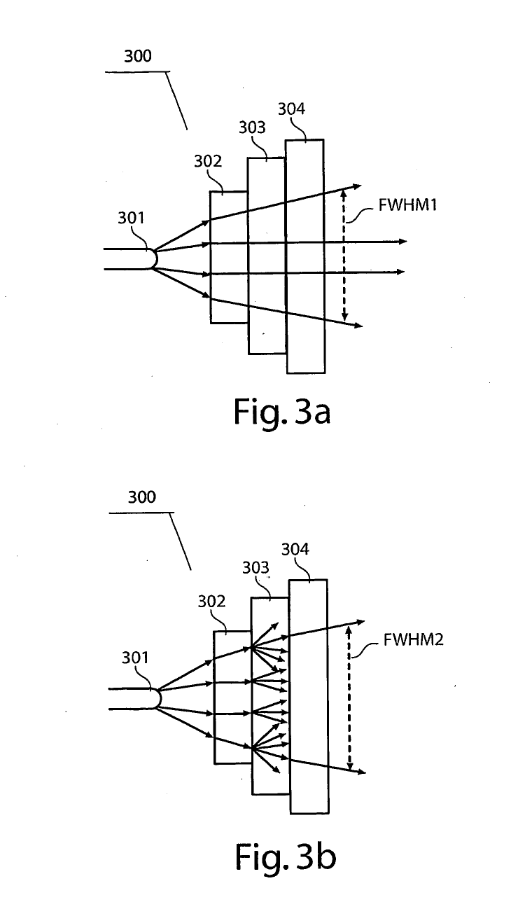

FIG. 3 shows a cross sectional view of another embodiment of the present invention, in which a device for electrically controlling shaping of a light beam is provided;

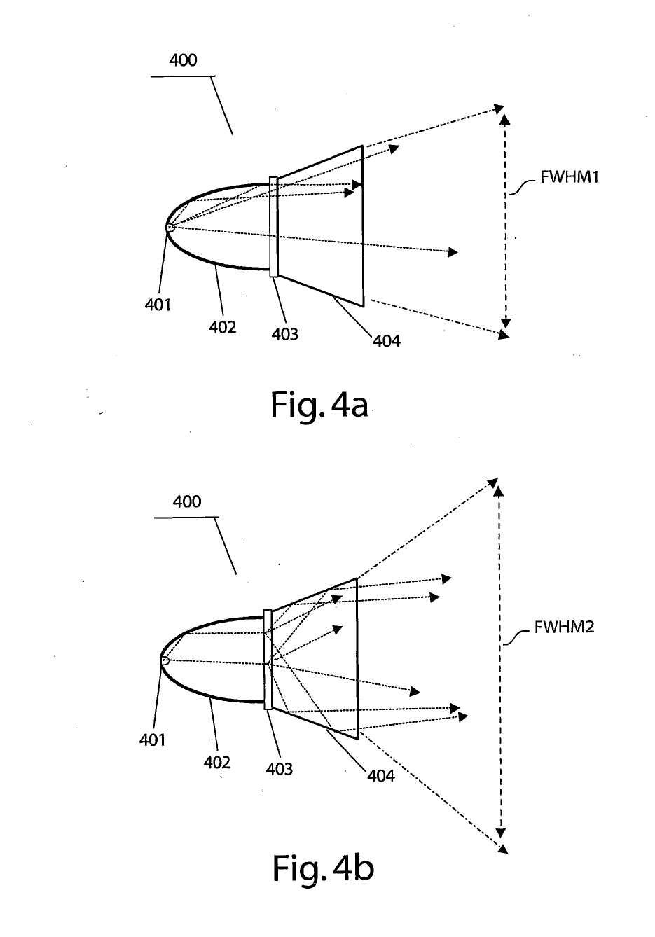

FIG. 4 shows a cross sectional view of yet another embodiment of the present invention, in which a device for electrically controlling shaping of a light beam is provided; and

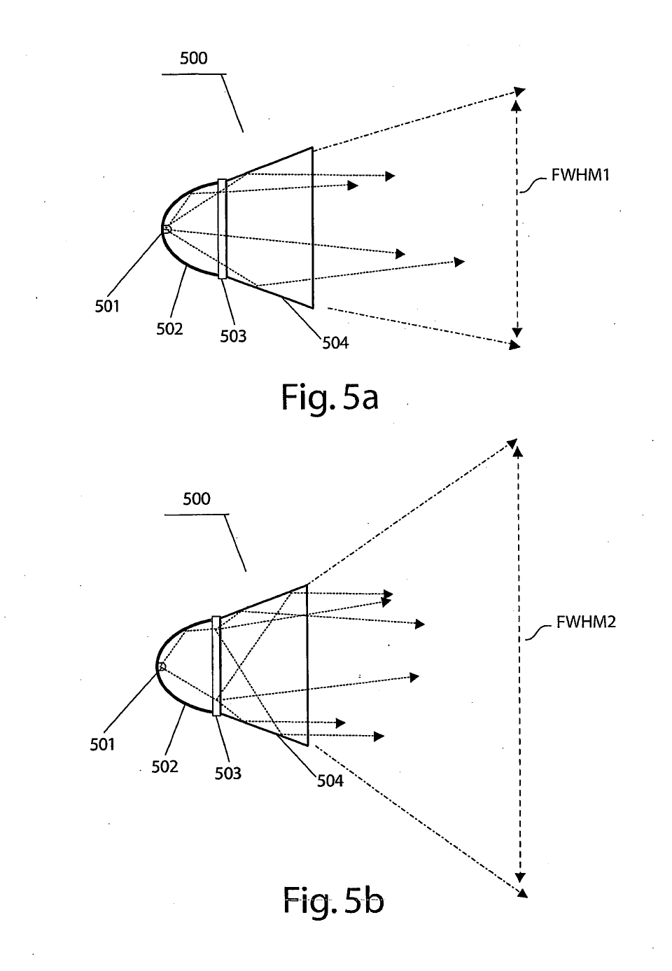

FIG. 5 shows a cross sectional view of still another embodiment of the present invention, in which a device for electrically controlling shaping of a light beam is provided.

FIG. 1 shows a cross sectional view of a prior art electrically controllable scattering element 101, which element is formed by using a PDLC material. FIG. 1a shows the scattering element in its light scattering mode, and FIG. 1b shows the scattering element in its transparent mode. The liquid crystal material 102 is embedded in a polymer matrix (104) arranged placed between two transparent, glass plates 103 with conducting layers of transparent electrodes 105, such as indium tin oxide (ITO). As shown in FIG. 1a, when no electric field is applied between the glass plates 103, the liquid crystals are randomly oriented with respect to each other, whereby light is scattered in many directions. When an electric field is applied, e.g. by means of a voltage generator 106 as shown in FIG. 1b, the liquid crystals align parallel to the electric field and light passes through the cell, creating the transparent mode. Cells formed by LC gel function in the opposite manner with regard to the applied electrical field: the liquid crystals are aligned when no electric field is applied, activating the transparent mode. When an electric field is applied, the liquid crystals scatter the light.

The LC gel material has the advantage that the cell will be in its transparent mode when the power is off, which in some applications might be preferred. For the choice of PDLC material versus LC gel material, one has to take into account the actual application.

FIG. 2 shows a preferred embodiment of the present invention, in which embodiment a device 200 for electrically controlling shaping of a light beam is provided. A schematic cross sectional view of the device 200 is shown. The device 200 comprises primary optics 202, an electrically controllable optical element 203 and secondary optics 204. The device may also comprise a light source 201, e.g. a LED, either integrated with the optics or added as a separate element depending on the particular application. In the following, it is assumed that the device does include a LED or cluster of LEDs 201. In case a number of LEDs are employed, the LEDs may be arranged such that a first LED emits a first primary color and a second LED emits a second primary color, which second primary color is different from the first primary color. Moreover, the device may be arranged such that the LEDs included in the cluster are arranged to be controlled independently.

FIG. 2a illustrates the device 200 when no electric field is applied to the transparent LC gel element 203, and FIG. 2b shows the device 200 when an electric field is applied to the optical element 203, whereby it redirects light beams impinging on it, either by providing a scattering, refracting or diffracting effect. In FIG. 2a, the light beam emitted by the LED 201 is shaped by the primary optics 202. The primary optics is implemented by means of e.g. a faceted-reflector and chosen such that, in combination with the secondary optics 204, a certain beam shaping is accomplished, e.g. a 2×5° spot beam, when the optical element 203 is in its transparent mode.

In FIG. 2b, the light beam is diffused by the optical element 203, which is placed in its light-redirecting mode by an electric field applied to the element. As illustrated in FIG. 2b, the beam is scattered in many different directions. The secondary optics 204 then re-shapes the scattered light beam. By changing the voltage applied across the cell, the ratio of light shaped by the secondary optics to non-scattered light (light that is emitted by the light source 201 and shaped by the primary optics) can be altered, which changes the shape of the resulting light beam.

FIG. 3 shows a cross sectional view of the device for electrically controlling shaping of a light beam according to another embodiment of the present invention where collimation of the light beam from the source 301 is done by the primary optics 302 only when the optical element 303 is in its transparent mode. Hence, the device 300 comprises primary optics 302, an electrically controllable scattering element 303, secondary optics 304 and a LED 301. FIG. 3a illustrates the device 300 when the optical element 303 is in the transparent mode, and FIG. 3b shows the device 300 when the optical element 303 is in its scattering mode. In FIG. 3a, the light beam emitted by the LED 301 is virtually unaffected by the secondary optics 304 and the scattering optical element 303. The primary optics 302, on the other hand, shapes the beam emitted by the light source 301. In FIG. 3b, the beam shaped by the primary optics 302 is scattered by the optical element 303. As illustrated in FIG. 3b, the beam is scattered to larger angles. The secondary optics 304 then reshapes the scattered beam to create a light beam having a desired divergence angle.

As can be seen from FIGS. 2 and 3, the basic idea is that the primary optics 202, 302 partially (as in FIG. 2) or completely (as in FIG. 3) shapes the beam to have a certain angular distribution and that the secondary optics 304, 304 shapes the beam to have another distribution of angles. By controlling the amount of light scattered by element 203, 303, the amount of light directed to the secondary optics is adjusted. The amount of light shaped by the secondary optics 204, 304 may be controlled by varying the electric field that is applied to the scattering element 203, 303. In this way, the shape of the light beam that originates from the light source 201, 301 can be adjusted. Using the device of the present invention, for an applied voltage to a PDLC element in the range of 0-40V, the full-width half-maximum (FWHM) angle can be varied from 50° at 40V to 80° at 0V. Any FWHM angle in between these extreme values may be accomplished by varying the applied voltage.

FIG. 4 shows a cross sectional view of the device for electrically controlling shaping of a light beam according to an embodiment of the present invention. The device 400 comprises primary optics 402, an electrically controllable scattering element 403, secondary optics 404 and a light source 401. The embodiment shown in FIG. 4 has the same optical function as the embodiment described in connection to FIG. 3. However, in FIG. 4, the primary optics 402 and the secondary optics 404 comprise metallic reflectors.

FIG. 5 shows a cross sectional view of the device for electrically controlling shaping of a light beam according to another embodiment of the present invention. The device 500 comprises primary optics 502, an electrically controllable scattering element 503, secondary optics 504 and a light source 501. The embodiment shown in FIG. 5 has the same optical function as the embodiment described in connection to FIG. 2. However, as in FIG. 4, the primary optics 502 and the secondary optics 504 comprise metallic reflectors.

Further, arrangements are possible in which multiple electrically controllable optical elements can be used in combination with other optical stages. In other words, multiple scattering elements and reflectors can be used in shaping the beam originating from a light source. Hence, a man skilled in the art realizes that a plurality of electrically controllable optical elements may be arranged in combination with static beam shaping elements.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A device (200, 300) for electrically controlling shaping of a light beam, which device comprises:
primary optics (202, 302) arranged to shape the light beam;
an electrically controllable optical element (203, 303) arranged to alter the shaped light beam when in a light redirecting mode; and
secondary optics (204, 304) arranged to shape the light beam altered by the electrically controllable optical element (203, 303).

2. The device (200) according to claim 1, wherein the primary optics (202) is arranged to shape the light beam, the electrically controllable optical element (203) is arranged to change the distribution of the shaped light beam when in a light redirecting mode and the secondary optics (204) is arranged to shape the light beam, the distribution of which has been changed.

3. The device (300) according to claim 1, wherein the electrically controllable optical element (303) is arranged to redirect the light beam when in the light redirecting mode and the secondary optics (304) is arranged to shape the redirected light beam only.

4. The device (200) according to claim 1, wherein the secondary optics (204) is further arranged to shape the light beam when the electrically controllable element (203) is in a transparent mode.

5. The device (200, 300) according to claim 1, wherein the electrically controllable optical element (203, 303) is arranged such that a voltage may be applied to said optical element to electrically control its redirection of light beams.

6. The device (200, 300) according to claim 5, wherein the electrically controllable optical element (203, 303) is arranged such that a varied applied voltage results in a varied divergence of the redirected beams.

7. The device (200, 300) according to claim 5, wherein the electrically controllable optical element (203, 303) is arranged such that a varied applied voltage results in that a varied fraction of the incoming beam becomes diverted.

8. The device (200, 300) according to claim 1, wherein the primary optics (202, 302) is arranged such that it exhibits total internal reflection.

9. The device (200, 300) according to claim 1, further comprising:
a light source (201, 301) for generating the light beam.

10. The device (200, 300) according to claim 8, wherein the light source (201, 301) comprises at least one light emitting diode.

11. The device (200, 300) according to claim 10, wherein the light source (201, 301) comprises at least a first light emitting diode emitting a first primary color and a second light emitting diode emitting a second primary color, which second primary color is different from the first primary color.

12. The device (200, 300) according to claim 11, wherein at least two light emitting diodes or clusters of light emitting diodes emitting different primary colors are arranged to be controlled independently.

13. The device (200, 300) according to claim 10, further comprising one or more temperature and/or optical sensors to provide, in combination with further electronics, a feedback and/or feed forward control system.

14. The device (200, 300) according to claim 1, wherein the electrically controllable optical element (203, 303) comprises liquid crystal elements, which are arranged to provide redirection of light.

15. The device (200, 300) according to claim 1, wherein the electrically controllable element (203, 303) comprises polymer dispersed liquid crystals.

16. The device (200, 300) according to claim 1, wherein the electrically controllable optical element (203, 303) comprises liquid crystal gels.

17. The device (200, 300) according to claim 1, wherein the electrically controllable optical element (203, 303) is arranged to scatter, refract or diffract light when in the light redirecting mode.

18. The device (200, 300) according to claim 1, wherein the primary optics can comprise multiple optical elements, the electrically controllable optical element can comprise multiple optical elements and the secondary optics can comprise multiple optical elements.
